(19) United States
(12) Patent Application Publication
(10) Pub. No.: US 2017/0255008 A1
(43) Pub. Date: Sep. 7, 2017

(54) SELF-CLEANING SURVEILLANCE DEVICE AND METHOD THEREOF

(71) Applicant: AV TECH CORPORATION, New Taipei City (TW)

(72) Inventors: HUANG-JEN CHIEN, New Taipei City (TW); CHIEN-YUEH CHEN, Taipei City (TW)

(73) Assignee: AV TECH CORPORATION

(21) Appl. No.: 15/360,467

(22) Filed: Nov. 23, 2016

(30) Foreign Application Priority Data
Mar. 7, 2016 (TW) 105106948

(51) Int. Cl. G02B 27/00; H04N 5/225; G06K 9/00; H04N 7/18

(52) U.S. Cl. CPC G02B 27/0006; H04N 7/183; H04N 5/2251; G06K 9/00771

(57) ABSTRACT

A self-cleaning surveillance device and a method using the same are provided. The self-cleaning surveillance device includes a surveillance device and a fan. The surveillance device includes an image capturing device and a processor. The image capturing device captures a surveillance image. The processor receives the captured surveillance image, compares the captured surveillance image with a preset condition, and then generates a drive signal corresponding to a mismatch between the surveillance image and the preset condition. The fan is disposed at an edge of a front end of the surveillance device and receives the drive signal. The fan blows air towards the front end of the surveillance device according to the drive signal in order to clean the front end of the surveillance device.

### CROSS-REFERENCE TO RELATED APPLICATION

This application claims priority from Taiwan Patent Application No. 105106948, filed on Mar. 7, 2016, in the Taiwan Intellectual Property Office, the content of which is hereby incorporated by reference in its entirety for all purposes.

### BACKGROUND OF THE INVENTION

1. Field of the Invention

The present invention relates to a control device and a control method, and more particularly to an automatic cleaning surveillance device and a method thereof with a fan to automatically clean the lens of a surveillance device.

2. Description of the Related Art

In general, surveillance cameras are disposed in high locations so that the camera's field of view covers the area to be monitored.

However, the installation of surveillance cameras in high inaccessible places implies that it is not easy to clean the dust and dirt that accumulates over time. Indeed, often the lens of the surveillance camera is not cleaned until the lens is very dirty or the surveillance image has become obscured. As a result, for much of the time, the image quality of the surveillance camera is poor and this affects its ability to monitor as intended.

### SUMMARY OF THE INVENTION

The primary object of the present invention is to provide a self-cleaning surveillance device and a method thereof to overcome the aforementioned problems of the prior art.

In order to achieve the above object, the present invention provides a self-cleaning surveillance device. The self-cleaning surveillance device includes a surveillance device and a fan. The surveillance device includes an image capturing device and a processor. The image capturing device is adapted to capture a surveillance image. The processor receives the surveillance image and compares the surveillance image with a preset condition. The processor generates a drive signal that corresponds to a mismatch between the surveillance image and the preset condition. The fan is disposed close to an edge of a front end of the surveillance device and receives the drive signal. The drive signal causes the fan to blow air towards the front end of the surveillance device, thus cleaning the front end of the surveillance device.

Preferably, the processor generates image information that corresponds to the surveillance image, and then compares the image information of the surveillance image with the preset condition. When the image information of the surveillance image does not match the preset condition, the processor generates the drive signal.

Preferably, the processor generates warning information according to the drive signal and then sends the warning information to a remote device.

Preferably, the processor selectively generates an on/off signal and then sends the on/off signal to the fan. The fan turns on or off according to the on/off signal.

Preferably, the edge of the front end of the surveillance device is provided with a retainer, and the fan is attached to the retainer.

Based on the above object, the present invention further provides a method to automatically clean a surveillance device, to be used by a self-cleaning surveillance device. The self-cleaning surveillance device includes a surveillance device and a fan. The surveillance device has an image capturing device and a processor. The method includes the steps of capturing a surveillance image; comparing the surveillance image with a preset condition; generating a drive signal that corresponds to a mismatch between the surveillance image and the preset condition; and blowing air towards a front end of the surveillance device according to the drive signal.

Preferably, before the step of comparing the surveillance image with the preset condition, the method further includes the steps of generating image information that corresponds to the surveillance image; comparing the image information with the preset condition; and generating the drive signal when the image information of the surveillance image does not match the preset condition.

Preferably, the method further includes the steps of generating warning information according to the drive signal; and sending the warning information to the remote device.

Preferably, the method further includes the steps of generating an on/off signal; and starting or stopping the blowing of air according to the on/off signal.

As described above, the processor of the self-cleaning surveillance device of the present invention is used to determine whether the lens of the surveillance device needs cleaning or not, according to the surveillance image. If the processor determines that the surveillance device needs cleaning, then the fan is driven to blow air towards the front end of the surveillance device. The fan may also be run continuously to form an air barrier in front of the lens that prevents dust, water and the like from attaching to the lens.

### BRIEF DESCRIPTION OF THE DRAWINGS

FIG. 1 is a first block diagram of a self-cleaning surveillance device of the present invention.

FIG. 2 is a second block diagram of the self-cleaning surveillance device of the present invention.

FIG. 3 is a first schematic of the self-cleaning surveillance device of the present invention.

FIG. 4 is a second schematic of the self-cleaning surveillance device of the present invention.

FIG. 5 is a first flow chart of a method to automatically clean a surveillance device of the present invention.

FIG. 6 is a second flow chart of the method to automatically clean a surveillance device of the present invention.

### DESCRIPTION OF THE PREFERRED EMBODIMENTS

The present invention will now be described, by way of embodiments and accompanying drawings, such that the advantages and features of the inventive concept and method of accomplishing the same may be more readily understood. The inventive concept may be embodied in many different forms and should not be construed as being limited to the embodiments set forth herein. Rather, these embodiments are provided as examples so that this disclosure will be thorough and complete, and will fully convey the aspects and features of the present invention to those skilled in the art. The description refers to the accompanying drawings, with like reference numbers referring to like elements throughout. Furthermore, the relative sizes of elements in the drawings should not be construed as being limited to those shown, as the proportions and arrangement shown in the drawings may be exaggerated for clarity.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The methods described herein may be implemented in software, hardware, or a combination thereof. In addition, parts of the steps of the method may be changed and various elements may be added, recorded combined, omitted, modified, etc.

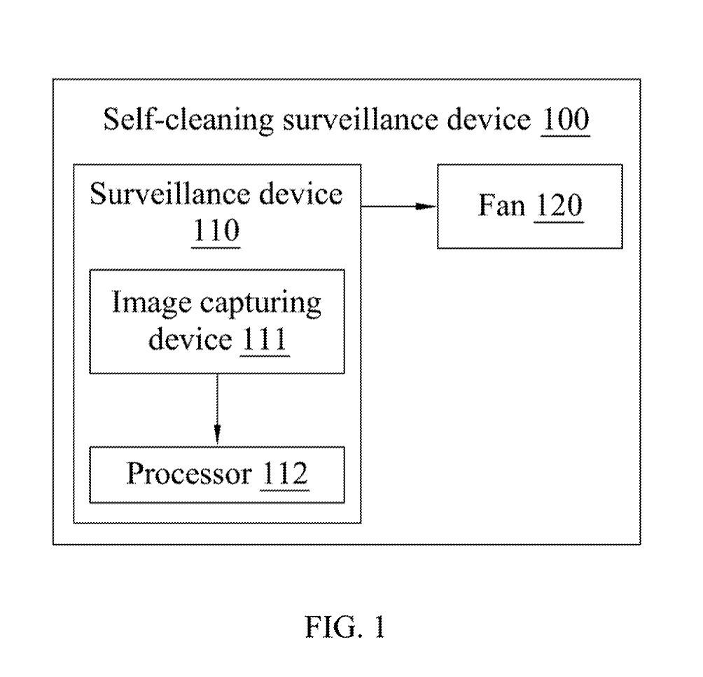

The following refers to FIG. 1, which is a first block diagram of a self-cleaning surveillance device of the present invention. The self-cleaning surveillance device 100 of the present invention includes a surveillance device 110 and a fan 120. The surveillance device 110 is electrically coupled with the fan 120.

The surveillance device 110 includes an image capturing device 111 and a processor 112. The image capturing device 111 is used to capture a surveillance image within the monitoring range of the surveillance device 110. The processor 112 receives the captured surveillance image from the image capturing device 111 and then compares the captured surveillance image with a preset condition to check whether the surveillance image matches the preset condition. The preset condition may be stored in the processor 112 in advance, or it may be adjusted and set according to the environment or the user's desire. The processor 112 generates a drive signal that corresponds to a mismatch between the surveillance image and the preset condition.

When the surveillance image does not match the preset condition, then this indicates that the quality of the captured surveillance image has been affected by the obscuring of a lens 101 of the surveillance device 110 by accumulated dust and dirt. The preset condition may be a standard image. The standard image may be a previously captured surveillance image. The surveillance image is compared with the standard image. If there is a difference detected between the surveillance image and the standard image, then this indicates that a foreign object is on the lens 101. To compare the two images, the processor 112 uses an algorithm to analyze the monitoring image, and compares the surveillance image to the preset condition to determine whether the surveillance image matches the preset condition.

When the surveillance image does not match the preset condition, then this indicates that there is dust or dirt present on a front end of the surveillance device 110 and so the device needs cleaning. A fan 120 is provided and disposed at an edge of the front end of the surveillance device 110 in order to blow off and thus clean the dust or dirt off the front end of the surveillance device 110, when required. When the surveillance image does not match the preset condition, the processor 112 generates the drive signal and sends the drive signal to the fan 120. The fan 120, triggered by the received drive signal, blows air towards the front end of the surveillance device 110 according to the drive signal, in order to clean the front end of the surveillance device 110.

In another embodiment, after the processor 112 receives the surveillance image, the processor 112 first generates image information that corresponds to the surveillance image, and then compares the image information of the surveillance image with the preset condition. When the image information of the surveillance image does not match the preset condition, the processor 112 will generate the drive signal. The image information may be a parameter of the image sharpness of the surveillance image. Such a parameter can be used to compare the surveillance image with the preset condition in order to determine whether the surveillance image is obscured or if there is a foreign object present on the lens 101, and so whether it is necessary to drive the fan 120 to clean the front end of surveillance device 110.

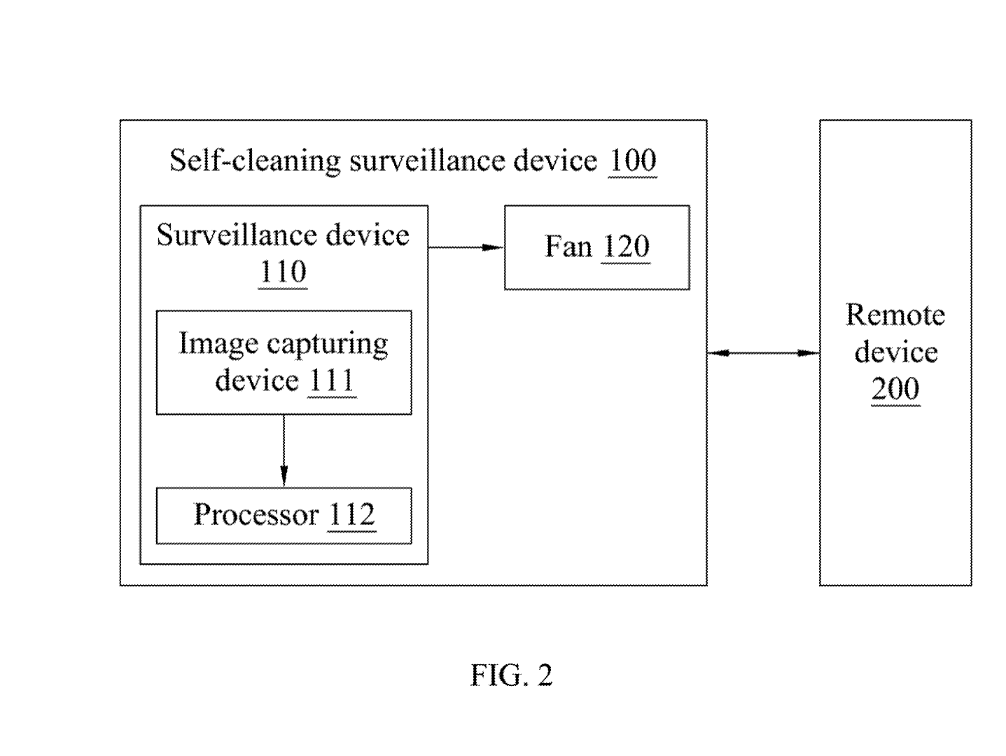

The following refers to FIG. 2, which is a second block diagram of the self-cleaning surveillance device of the present invention. The self-cleaning surveillance device 100 of the present invention may be wirelessly connected (or connected through a wire or wires) to a remote device 200. The processor 112 may generate warning information according to the drive signal and send the warning information to the remote device 200. The warning information may be a light indicator, sound, text or a combination thereof, and the purpose of the warning information is to warn the person who is monitoring or using the remote device 200 that the surveillance device 110 is obscured due to accumulated dust or dirt and needs cleaning. Additionally, the processor 112 may be limited to generate the drive signal for a predetermined number of times in a preset period, and then to generate the warning information to the remote device 200. This warning information indicates that the dust or dirt at the front end of the surveillance device 110 cannot be cleaned by the fan 120 blowing air at the front end of the surveillance device 110 or that the fan 120 has malfunctioned. In this case the surveillance device has to be checked and cleaned manually. In addition, the remote device 200 may be used to set and change the preset condition for the processor 112.

In addition to driving the fan 120 when there is a mismatch between the surveillance image and the preset condition, the processor 112 may also selectively generate an on/off signal and then send the on/off signal to the fan 120. The fan 120 is then turned on or off according to the on/off signal. In such a case, the fan 120 may be controlled by the on/off signal regardless of whether the surveillance device 110 is obscured with dust or dirt. For instance, the fan 120 may be run continuously to form an air barrier in front of the surveillance device 110 that prevents dust, water and the like from attaching to the lens 101. The remote device 200 may further be used to generate and send the on-off signal to control the fan 120 remotely.

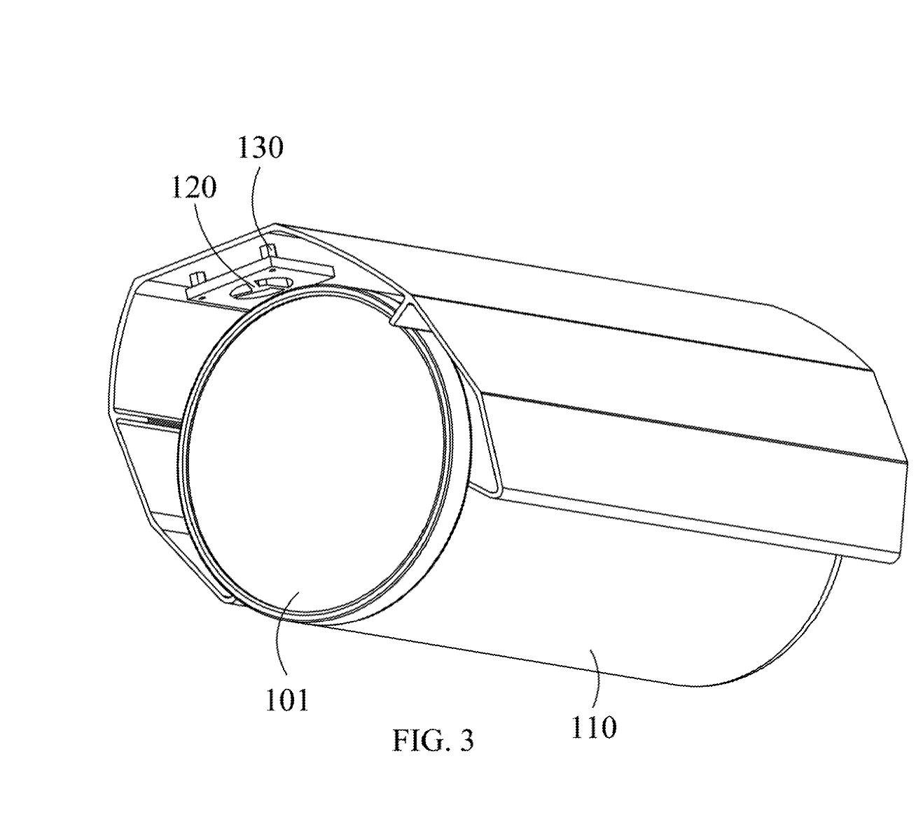

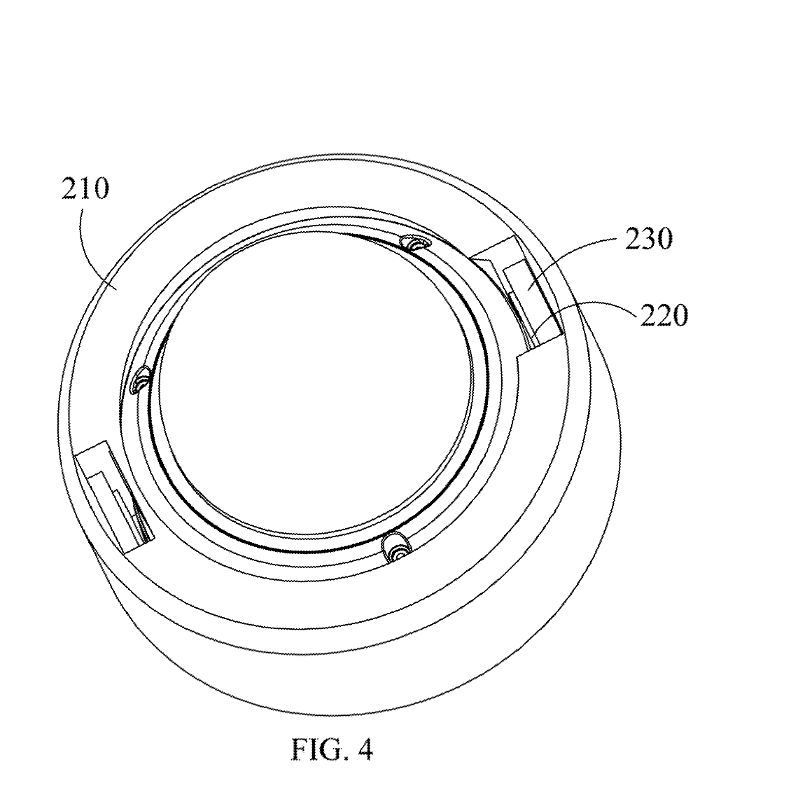

The following refers to FIGS. 3 and 4, which are respectively, first and second schematics of the self-cleaning surveillance device of the present invention. The surveillance device 110, as shown in FIG. 3, is a cylinder-type surveillance camera. The edge of the front end of the surveillance device 110 is provided with a retainer 130. The fan 120 is attached to the retainer 130. The surveillance device 210, as shown in FIG. 4, is a dome-type surveillance camera. The surveillance device 210 is provided with two fans 220; however, the number of fans is not limited thereto. The edge of the front end of the surveillance device 210 is provided with two retainers 230. The fans 220 are individually attached to each of the retainers 230.

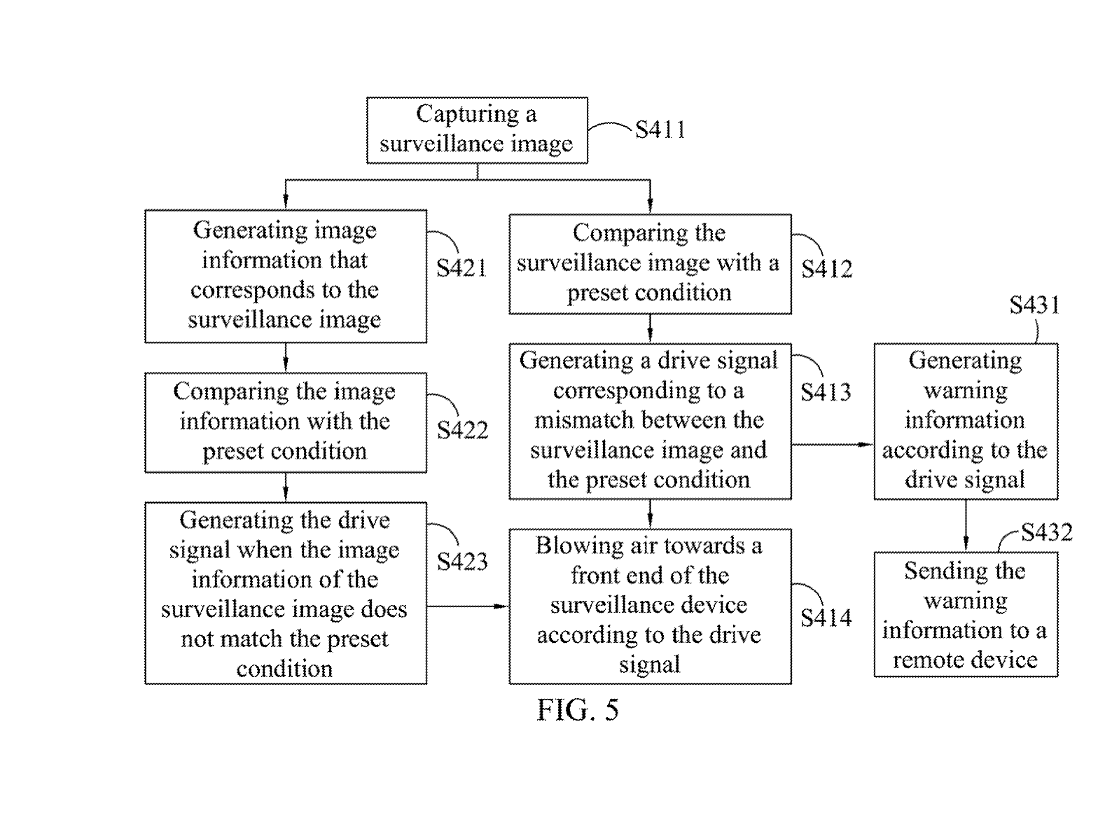

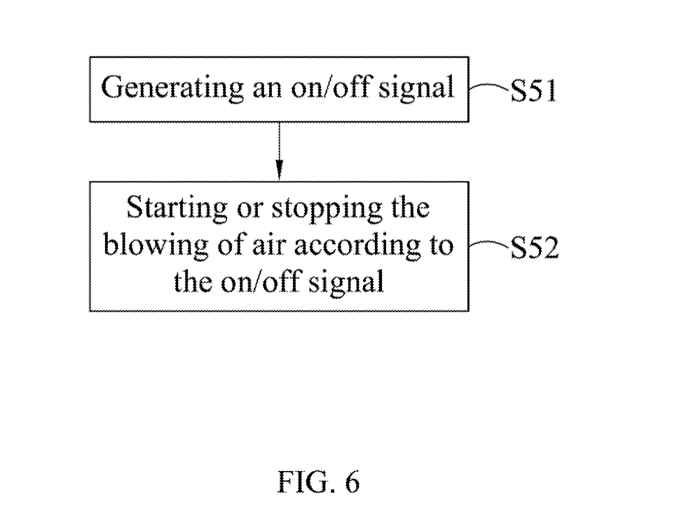

In the above description of the self-cleaning surveillance device of the present invention, the concept of a method to automatically clean a surveillance device of the present invention has also been illustrated. For convenience, the method of the present invention is also described in detail below. Described and reproduced are the steps of first and second flow charts of FIGS. 5 and 6 respectively.

The following refers to FIG. 5, which is the first flow chart of a method to automatically clean a surveillance device of the present invention. The method to automatically clean a surveillance device of the present invention is used to automatically clean a self-cleaning surveillance device 100 of the present invention. The self-cleaning surveillance device includes a surveillance device and a fan. The surveillance device includes an image capturing device and a processor. The method to automatically clean a self-cleaning surveillance device of the present invention includes the following steps:

S411: Capturing a surveillance image. The image capturing device captures a surveillance image within the monitoring range of the surveillance device.

S412: Comparing the surveillance image with a preset condition. After the processor of the surveillance device receives the surveillance image, the processor compares the surveillance image with a preset condition. However, it is not necessary for the comparison to be made continuously. The processor may make the comparison at predetermined intervals of time.

S413: Generating a drive signal corresponding to a mismatch between the surveillance image and the preset condition.

S414: Blowing air towards a front end of the surveillance device according to the drive signal. The fan is provided to blow air towards the front end of the surveillance device (where the lens of the surveillance device is disposed).

In an alternative embodiment, before the step of comparing the surveillance image with the preset condition, the method further includes the following steps:

S421: Generating image information that corresponds to the surveillance image. The processor uses an algorithm to analyze the surveillance image or the processor uses an image processing technique to generate the image information.

S422: Comparing the image information with the preset condition.

S423: Generating the drive signal when the image information of the surveillance image does not match the preset condition. That is to say, in this alternative embodiment it is the image information of the surveillance image that is used as a basis to determine whether to drive the fan or not.

The method to automatically clean a surveillance device of the present invention may also include the following steps:

S431: Generating warning information according to the drive signal. The warning information is generated by the processor.

S432: Sending the warning information to a remote device.

The following refers to FIG. 6, which is a second flow chart of the method to automatically clean a surveillance device of the present invention. The method to automatically clean a surveillance device of the present invention may also include the following steps:

S51: Generating an on/off signal. The on/off signal is generated by the processor or the remote device and then sent to the fan. When the on/off signal is generated by the remote device, the on/off signal is sent to the fan through the processor.

S52: Starting or stopping the blowing of air according to the on/off signal.

In summary, the self-cleaning surveillance device and method of the present invention uses the processor to determine whether the lens of the surveillance device needs to be cleaned or not by checking the surveillance image. Then, should the lens require cleaning, the processor drives the fan to blow air towards the front end of the surveillance device. The fan may also be run continuously to form an air barrier layer in front of the lens that prevents dust, water and the like from coming into contact with the lens.

The invention disclosed herein has been described by means of specific embodiments. However, numerous modifications, variations and enhancements can be made thereto by those skilled in the art without departing from the spirit and scope of the invention set forth in the claims.

What is claimed is:

1. A self-cleaning surveillance device, comprising:
a surveillance device, comprising:
an image capturing device, capturing a surveillance image; and
a processor, receiving the surveillance image, then comparing the surveillance image with a preset condition, and then generating a drive signal that corresponds to a mismatch between the surveillance image and the preset condition; and
a fan, disposed close to an edge of a front end of the surveillance device, receiving the drive signal, and then blowing air towards the front end of the surveillance device according to the drive signal in order to clean the front end of the surveillance device.

2. The self-cleaning surveillance device as claimed in claim 1, wherein the processor generates image information that corresponds to the surveillance image, compares the image information of the surveillance image with the preset condition, and when the image information of the surveillance image does not match the preset condition, the processor generates the drive signal.

3. The self-cleaning surveillance device as claimed in claim 1, wherein the processor generates warning information according to the drive signal and sends the warning information to a remote device.

4. The self-cleaning surveillance device as claimed in claim 1, wherein the processor selectively generates an on/off signal and sends the on/off signal to the fan, and the fan is turned on or off according to the on/off signal.

5. The self-cleaning surveillance device as claimed in claim 1, wherein the edge of the front end of the surveillance device is provided with a retainer, and the fan is attached to the retainer.

6. A method to automatically clean a surveillance device, used to automatically clean a self-cleaning surveillance device, the self-cleaning surveillance device comprising a surveillance device and a fan, the surveillance device comprising an image capturing device and a processor, and the method comprising the steps of:
capturing a surveillance image;
comparing the surveillance image with a preset condition;
generating a drive signal corresponding to a mismatch between the surveillance image and the preset condition; and
blowing air towards a front end of the surveillance device according to the drive signal.

7. The method as claimed in claim 6, wherein before the step of comparing the surveillance image with the preset condition, the method further comprises the steps of:
generating an image information that corresponds to the surveillance image;
comparing the image information with the preset condition; and
generating the drive signal when the image information of the surveillance image does not match the preset condition.

8. The method as claimed in claim 6, further comprising the steps of:
generating warning information according to the drive signal; and
sending the warning information to a remote device.

9. The method as claimed in claim 6, further comprising the steps of:
generating an on/off signal; and
starting or stopping the blowing of air according to the on/off signal.

10. The method as claimed in claim 6, wherein an edge of the front end of the surveillance device is provided with a retainer, and the fan is attached to the retainer.
